(19) United States
(12) Patent Application Publication
(10) Pub. No.: US 2010/0235914 A1
(43) Pub. Date: Sep. 16, 2010

(54) INTRUSION DETECTION FOR VIRTUAL LAYER-2 SERVICES

(75) Inventor: Denis Armand Proulx, Kanata (CA)

Correspondence Address: Terry W. Kramer, Esq.;Kramer & Amado, P.C., 1725 Duke Street, Suite 240, Alexandria, VA, 22314, US

(73) Assignee: ALCATEL LUCENT, Paris (FR)

(21) Appl. No.: 12/404,023

(22) Filed: Mar. 13, 2009

(51) Int. Cl. G06F 21/06

(52) U.S. Cl. 726/23

(57) ABSTRACT

The invention is directed to detecting an attempt of an intruder system to participate in a virtual Layer-2 service provided over a packet switching network. Embodiments of the invention monitor operational status of an interface port of a PE router to which a CE router is communicatively coupled for providing the virtual Layer-2 service, determine, consequent to a change in said status, whether information that should relate to the CE router has changed; and thereby, in the affirmative, interpret said change to indicate that an intruder system has attempted to participate in the virtual Layer-2 service. Advantageously, this capability is complementary to other security measures such as MAC filters and Anti-spoofing filters that depend on the content of data packets exchanged between the CE and PE routers and not on the operational status of communicative connections between them.

### FIELD OF THE INVENTION

The invention is directed to packet switching communication networks, particularly to providing intrusion detection for virtual Open System Interconnection (OSI) Layer-2 services such as Virtual Leased Line (VLL) and Virtual Private LAN Service (VPLS) services.

### BACKGROUND OF THE INVENTION

Virtual Leased Line (VLL) is a service for providing Ethernet based point to point communication over Internet Protocol (IP) and Multi Protocol Label Switching (MPLS) networks (IP/MPLS). This technology is also referred to as Virtual Private Wire Service (VPWS) or Ethernet over MPLS (EoMPLS). The VPWS service provides a point-to-point connection between two Customer Edge (CE) routers. It does so by binding two attachment circuits (AC) to a pseudowire that connects two Provider Edge (PE) routers, wherein each PE router is connected to one of the CE routers via one of the attachment circuits. VLL typically uses pseudowire encapsulation for transporting Ethernet traffic over an MPLS tunnel across an IP/MPLS backbone. More information on pseudowires can be found in “Pseudo Wire Emulation Edge-to-Edge (PWE3) Architecture”, RFC3985, IETF, March 2005, by S. Bryant and P. Pate.

Virtual Private LAN Service (VPLS) is an Ethernet service that effectively implements closed user groups via VPLS instantiations. In order to achieve full isolation between the user groups, VPLS dedicates a separate forwarding information base (FIB) on network routers per VPLS instance. Each VPLS instance further requires that a dedicated mesh of pseudowire tunnels is provisioned between PE routers that are part of the VPLS.

Both VLL and VPLS services use Service Access Points (SAP) to bind tunnel endpoints at PE router ports to their respective service. For example, in the case of VPLS service, a SAP would specify physical identifiers (e.g. node, shelf, card, port) of the corresponding port and an identifier (e.g. VLAN5) of the VPLS.

In some cases a CE router is located in a remote or otherwise vulnerable location with respect to network security. In these cases it is desirable to have security measures in place that can respond to an intruder system participating in, or attempting to participate in, a virtual Layer-2 service provided by the CE router such as a VLL or VPLS service. Such an intruder system includes any system that is unauthorized to participate in the virtual Layer-2 service.

### SUMMARY

The invention is directed to detecting an attempt of an intruder system to participate in a virtual Layer-2 service provided over a packet switching network.

Some embodiments of the invention monitor operational status of an interface port of a PE router to which a CE router is communicatively coupled for providing a virtual Layer-2 service, determine, consequent to a change in said status, whether information that should relate to the CE router has changed; and thereby, in the affirmative, interpret said change to indicate that an intruder system has attempted to participate in the virtual Layer-2 service.

In some embodiments of the invention an identifier of an interface port selected for security monitoring is stored and an operational status of that interface port is determined. Dependent upon the operational status of the interface port indicating that the interface port is in an operational state, an initial version of information relating to a CE router communicatively coupled to the interface port for providing a virtual Layer-2 service is recorded. The operational status of the interface port is then monitored for a state change. Upon detecting the state change, a current version of the information is obtained and compared to the initial version of the information. Consequent to detecting a difference between the versions of the information, an alert is raised indicating that an intruder system has attempted to participate in the virtual Layer-2 service.

In some embodiments of the invention the specific information includes one or more Media Access Control (MAC) or IP addresses stored in a forwarding information base (FIB) of a PE router at which the interface port is located.

In some embodiments of the invention the specific information includes one or more MAC or IP addresses of the CE router. Additionally, or alternatively, in some embodiments the specific information includes other information relating to the CE router which is obtainable via command line interface (CLI) commands issued to the CE router.

In some embodiments of the invention the CE and PE routers can be accessed via CLI commands issued to a network management system of the packet switching network and the operational status of the interface port can be monitored via event notifications issued by the network management system.

Embodiments of the invention are capable of detecting when a communicative connection between a CE router and a PE router for providing a virtual Layer-2 service is broken, as could occur when an intruder system is connected to the PE router in place of the CE router in an attempt to participate in the virtual Layer-2 service. Advantageously, this capability is complementary to other security measures such as MAC filters and Anti-spoofing filters that depend on the content of data packets exchanged between the CE and PE routers and not on the operational status of communicative connections between them.

### BRIEF DESCRIPTION OF THE DRAWINGS

The foregoing and other objects, features and advantages of the invention will be apparent from the following more particular description of the preferred embodiments, as illustrated in the appended drawings, where:

FIG. 1 illustrates a network configuration for detecting an attempt of an intruder system to participate in a Layer-2 service according to an embodiment of the invention; and

FIG. 2 illustrates a method of detecting an attempt of an intruder system to participate in a virtual Layer-2 service according to the embodiment depicted in FIG. 1.

In the figures like features are denoted by like reference characters.

### DETAILED DESCRIPTION

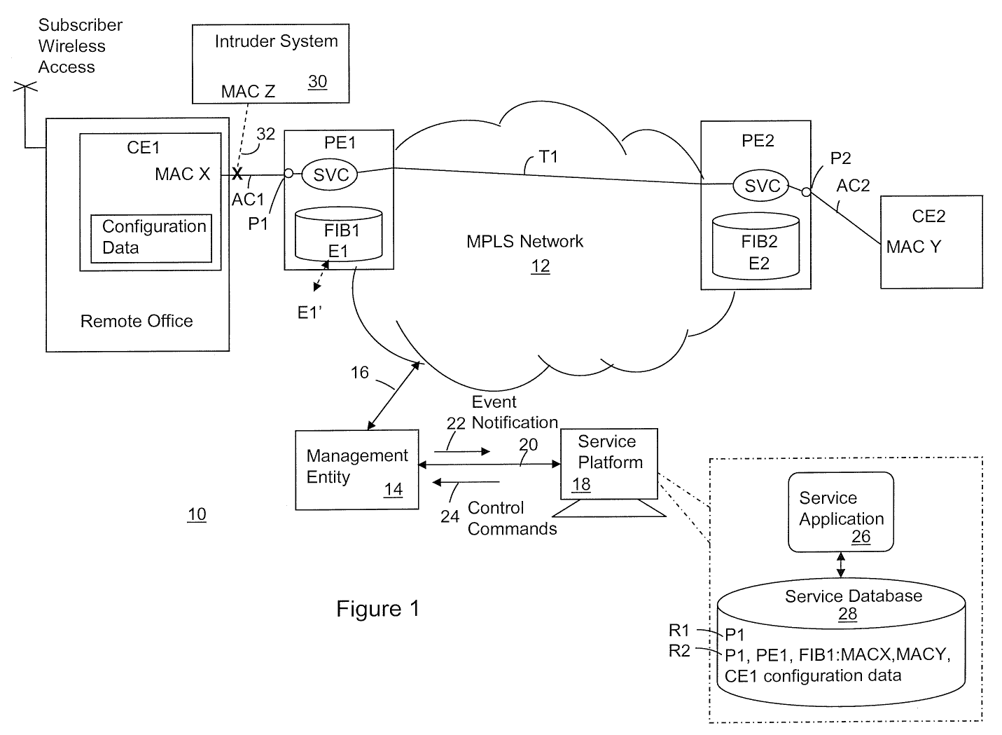

Referring to FIG. 1, a network configuration 10 for providing a VPLS service over an MPLS network 12 includes a pseudowire tunnel T1 routed through the MPLS network 12 between a first provider edge router PE1 and a second provider edge router PE2. The pseudowire tunnel T1 has two endpoints, a first of which is at the first provider edge router PE1 and a second of which is at the second provider edge router PE2. A service instance SVC of the VPLS service is instantiated at each of the provider edge routers PE1, PE2 and associates the pseudowire tunnel T1 with the VPLS service. Accordingly, data packets associated with the VPLS service are communicated through the MPLS network 10 via the pseudowire tunnel T1 between the first and second provider edge routers PE1, PE2.

Typically, there would be multiple pseudowire tunnels connecting multiple provider edge routers. In some cases these tunnels form a fully connected mesh interconnecting the provider edge routers. In any case, when there are multiple pseudowire tunnels for a given service that terminate on a provider edge router, a forwarding information base is used at that router to determine over which of the tunnels a data packet should be forwarded to reach its destination. This determination is made based on the destination MAC or IP address of the data packet. A MAC address is a 48 bit address that is generally unique and dedicated to a given network interface card or adapter of a data communication system. A MAC address is also known as a hardware address. An IP address is a 32 bit (IPv4) or 128 bit (IPv6) address that is generally unique to a network interface or system but is assignable in software.

A first customer edge router CE1 is connected to a first interface port P1 of the first provider edge router PE1 via a first attachment circuit AC1. The first customer edge router CE1 has a first MAC address X. Similarly, a second customer edge router CE2 is connected to a second interface port P2 of the second provider edge router PE2 via a second attachment circuit AC2. The second customer edge router CE2 has a second MAC address Y.

The first provider edge router PE1 includes a first forwarding information base FIB1 associated with the service instance SVC. The first forwarding information base FIB1 includes a first entry E1 for the pseudowire tunnel T1. The first entry E1 associates the first MAC address X with the second MAC address Y for the purpose of communicating data packets between the first and second customer edge routers CE1, CE2. Similarly, the second provider edge router PE2 includes a second forwarding information base FIB2 associated with the service instance SVC. The second forwarding information base FIB2 includes a second entry E2 for the pseudowire tunnel T1. The second entry E2 associates the first MAC address X with the second MAC address Y for the purpose of communicating data packets between the first and second customer edge routers CE1, CE2.

A first service access point at the first provider edge router PE1 associates the first interface port P1 with the service instance SVC, such that data packets received at the first interface port P1 from the first attachment circuit AC1 that are associated with the VPLS service are forwarded over a pseudowire tunnel in accordance with information in the first forwarding information base FIB1. Such information includes the first entry E1 in the first forwarding information base FIB1, which in this case causes data packets with a source MAC address being the first MAC address X to be forwarded over the pseudowire tunnel T1 when their destination MAC address is the second MAC address Y. Similarly, data packets associated with the VPLS service received by the first provider edge router PE1 from the pseudowire tunnel T1 are forwarded to the first interface port P1 in accordance with information in the first service access point and the first forwarding information base FIB1.

A second service access point at the second provider edge router associates the second interface port P2 with the service instance SVC, such that data packets received at the second interface port P2 from the second attachment circuit AC2 that are associated with the VPLS service are forwarded over a pseudowire tunnel in accordance with information in the second forwarding information base FIB2. Such information includes the second entry E2 in the second forwarding information base FIB2, which in this case causes data packets with a source MAC address being the second MAC address Y to be forwarded over the pseudowire tunnel T1 when their destination MAC address is the first MAC address X. Similarly, data packets associated with the VPLS service received by the second provider edge router PE2 from the pseudowire tunnel T1 are forwarded to the second interface port P2 in accordance with information in the second service access point and the first forwarding information base FIB1.

In view of foregoing it should be clear that data packets associated with the VPLS service can be communicated between the first and second customer edge routers CE1, CE2 via their respective attachment circuits AC1, AC2, the first and second provider edge routers PE1, PE2, and the pseudowire tunnel T1. However, as previously mentioned in some cases a CE router is located in a remote or otherwise vulnerable location with respect to network security. In these cases it is desirable to have security measures in place that can respond to an intruder system participating in, or attempting to participate in, a virtual Layer-2 service provided by the CE router such as a VLL or VPLS service. Such an intruder system includes any system that is unauthorized to participate in the virtual Layer-2 service.

Still referring to FIG. 1, the network configuration 10 includes a management entity 14 that is communicatively coupled to the provider edge routers PE1, PE2 via a control connection 16 and the MPLS network 12. The management entity 14 would typically be a network management system capable of performing operation, administration and maintenance (OAM) type functions on network elements in the MPLS network 12 such as the provider edge routers PE1, PE2. This functionality of the management entity 14 includes the capability to receive reports of equipment, service, and provisioning related events from network elements of the MPLS network 12, including event reports from the first and second provider edge routers PE1, PE2 regarding operational status of their respective interface ports P1, P2, among other things.

The network configuration 10 also includes a service platform 18 that is communicatively coupled to the management entity 14 via an open operating system (OS) interface 20. Using the open OS interface 20, the service platform 18 has access to event notifications 22, which include event notifications related to the event reports from the network elements. Further using the open OS interface 20 the service platform 18 can issue control commands 24 to the management entity 14 including commands to effect provisioning changes at the provider edge routers PE1, PE2. The service platform 18 would typically be a laptop or desktop computer or workstation. The open OS interface is a Java message service (JMS) interface; although other types of message interfaces could be used.

The service platform 18 executes a service application 26 that is in communication with a service database 28 on the service platform 18, although the service database 28 could also reside on the management entity 14 with access to it given by the open OS interface 20. The service application 26 is a software program that embodies a method of detecting an attempt of an intruder system to participate in a virtual Layer-2 service in accordance with an embodiment of the invention.

According to the method, the service application 26 monitors event notifications 22 received over the open OS interface 20. The service application 26 checks the event notifications 22 to determine if any of them relate to an operational status of an interface port selected for security monitoring. An identifier of each port so selected is stored in a first record R1 of the service database 28. For any such port, information contained in FIB entries of FIBs corresponding to VPLS services provided via that port would have already been retrieved from the associated PE router and stored in the service database 28. For example, in the case of the first interface port P1, information from the first entry E1 in the first forwarding information base FIB1 is stored in a second record R2 of the service database 28. The second record R2 includes the identifier of the first port P1, although it can be associated to the first port P1 by other means. Additionally or alternatively, other information relating to the CE router communicatively coupled to the port by an attachment circuit could be retrieved from that CE router and stored in the service database 28. For example, configuration data of the first customer edge router CE1 is also stored in the second record R2 of the service database 28. The information contained in the second record R2 would preferably be retrieved by the service platform 18 using control commands issued to the management entity 14 over the OS interface 20, although other ways could work. Such information would be retrieved when the port is selected for security monitoring or when security monitoring is reinitialized on the port and the port is in an operational state.

It should be understood that there are many ways of storing all or some of the information contained in the first and second records R1, R2. However, any of these ways should suffice if they enable identification of a port on which security monitoring is to be performed and provide information relating to the CE router communicatively coupled to that port when such security monitoring was activated and the port was in an operational state. For example, the first record R1 could be omitted if the second record R2 contained identification of the first port P1 and was stored in a manner indicating that the second record R2 contained information that related to a port on which security monitoring was to be performed. For example, such a manner could be to store the second record R2 in a special part of the service database 28 or in a group of similar records.

Still referring to FIG. 1, the first customer edge router CE1 is shown as being in a remote office such as a small building or cabin in an unpopulated area that is not visited by support staff of the packet switching network for long periods. Such a location is an example of vulnerable location with respect to network security. In an attempt to participate in the VPLS service, an intruder system 30 is communicatively connected to the first port P1 by disconnecting the first attachment circuit AC1 at the first customer edge router CE1 and reconnecting 32 the first attachment circuit AC1 to the intruder system 30. However, disconnecting and reconnecting the first attachment circuit AC1 causes the first interface port P1 to transition from an operational state to a non-operational state and back to an operational state again. Additionally, an address resolution protocol running on the first provider edge router PE1 will learn a third MAC address Z of the intruder system 30 from data packets sent over the first attachment circuit AC1 by the intruder system 30. The first provider edge router PE1 will update information contained in the first forwarding information base FIB1 to a current version. For example, the first entry E1 will be updated to a current version E1′ of the first entry.

The service application 26 is monitoring event notifications 22 from which it can detect a transition in the operational status of interface ports such as from an operational state to a non-operational state and visa versa. Upon detecting a change in operational status of an interface port, the service application 26 accesses information in the service database 28, such as the first record R1, to determine if the affected port is one that has been selected for security monitoring. In the affirmative, the service application 26 retrieves current information contained in FIB entries of FIBs corresponding to VPLS services provided via that port. The service application 26 retrieves this information from the PE router to which the affected port belongs. The relevant FIB is identified by information contained in the SAP that associates the affected port with a service instance, since a dedicated FIB exists in the PE router for each instance of a VPLS service. For example, upon detecting a change in the operational status of the first interface port P1, the service application 26 issues control commands 24 to the management entity 14 to retrieve the current version E1′ of the first entry in the first forwarding information base FIB1.

The service application 26 then accesses the service database 28 to retrieve an initial version of information relating to the first customer edge router CE1. This information is referred to as initial in that it was retrieved from the PE router, and alternatively or additionally the CE router, when security monitoring on the affected port was enabled or reinitialized. For example, the service platform 26 retrieves information contained in the second record R2. The initial version of the information is compared to the current version of the information, and consequent to detecting a mismatch between any information contained in the current and initial versions that should match, the service application 26 interprets the mismatch as indicating that an intruder system has attempted to participate in the virtual Layer-2 service. For example, the service application 26 compares the MAC addresses of the CE router communicatively coupled to the first attachment circuit AC1 that has been stored in the second record R2 and in the current version E1′ of the first entry. In this case there is a mismatch because the second record R2 contains the first MAC address X and the current version E1′ of the first entry contains the third MAC address Z. Additionally or alternatively, in a similar manner initial and current versions of other information relating to the CE router or system communicatively coupled to the affected port could be compared for a mismatch. For example any data such as configuration data that is retrievable from a CE router and that is unlikely or too difficult to be cloned by an intruder system could be used for the comparison.

Upon making a determination that an intruder system has attempted to participate in the virtual Layer-2 service via an interface port selected for security monitoring, the service application 26 disables the affected interface port and issues an alert to an operator, such as raising a network alarm or sending an e-mail or other type of electronic message to an operator or other entity responsible for secure operation of the virtual Layer-2 service. The service application 26 disables the affected interface port by issuing control commands to the management entity 14 in order to put the affected interface port in a non-operational state. For example, the service application 26 issues control commands 24 to the management entity 14 over the OS interface 20 to cause the first interface port P1 to transition into a non-operational state.

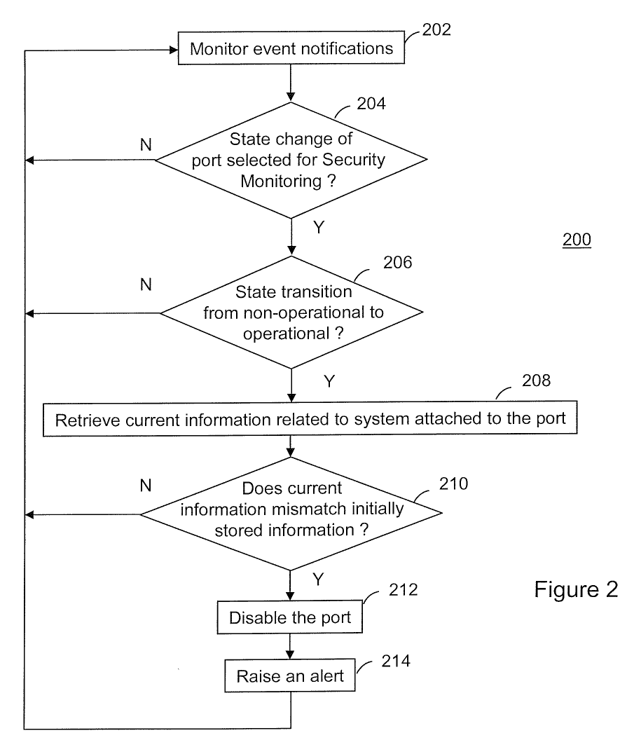

Referring to FIG. 2, a method 200 detecting an attempt of an intruder system to participate in a virtual Layer-2 service will now be described with additional reference to FIG. 1. The method 200 includes monitoring 202 event notifications of selected interface ports. Selection of the interface ports would preferably be performed using the service application 26, but could also be performed by another application running on the service platform 18 or management entity 14. Recordation of these selections would preferably be stored at the service platform 18, e.g. in the service database 28, but they could also be stored at the management entity 14, or in both locations. It is sufficient for performing the method 200 that an indication of interface ports to be security monitored is available to an entity such as the service application 26 that performs the method 200 automatically without human intervention. Such indication would include an identifier of each such port to be security monitored. The event notifications are monitored by receiving event notifications 22 from the management entity 14 via the open OS interface 20.

A determination 204 is made whether an event notification of a selected interface port indicates that the operational status of the interface port has changed. If the operational status of the affected port changed from an operational state to a non-operational the method waits for a further change to an operational state to occur. Upon detecting 206 a transition in the operational state of the affected port from a non-operational state to an operational state, the service application retrieves 208 current information relating to the system that is communicatively coupled to the affected interface port. This information would preferably be the MAC address of the system but could be any other information such as configuration data that would be unlikely to reside on an intruder system.

A determination 210 is made whether the retrieved current information mismatches information previously retrieved relating to the CE router that was communicatively coupled to the affected interface port. Consequent to a mismatch being detected the affected interface port is disabled 212 and an alert is raised 214. The method 200 then returns to monitoring 202 event notifications 22.

Numerous modifications, variations and adaptations may be made to the embodiments of the invention described above without departing from the scope of the invention, which is defined in the claims.

What is claimed is:

1. A method of detecting an attempt of an intruder system to participate in a virtual Layer-2 service in a packet switching network, comprising the steps of:
monitoring operational status of an interface port of a provider edge router to which a customer edge router is communicatively coupled for providing the virtual Layer-2 service;
detecting a change has occurred in said status;
determining information that should relate to the customer edge router has changed; and
interpreting said change to indicate that an intruder system has attempted to participate in the virtual Layer-2 service.

2. The method of claim 1, wherein the method further comprises the step of:
recording an identifier of the interface port thereby indicating that the interface port has been selected for security monitoring;
storing an initial version of the information when security monitoring of the interface port is enabled and the interface port is in an operational state.

3. The method of claim 2, wherein the step of determining comprises:
retrieving a current version of the information; and
comparing the current version to the initial version.

4. The method of claim 3, wherein the information includes one or more Media Access Control or Internet protocol addresses stored in a forwarding information base of the provider edge router.

5. The method of claim 4, wherein the information additionally or alternatively includes other information relating to the customer edge router which is obtainable from the customer edge router via a management entity.

6. The method of claim 1, wherein the virtual Layer-2 service is a virtual private local area network service or a virtual leased line service.

7. The method of claim 1, wherein the step of monitoring comprises monitoring event notifications reported by a network management entity over an operating system interface.

8. The method of claim 7, wherein the operating system interface is a Java messaging system interface.

9. A system for detecting an attempt of an intruder system to participate in a virtual Layer-2 service in a packet switching network, comprising:
a service platform for executing a service application stored thereon, the service platform comprising:
means for communicatively coupling to a network management entity of the packet switching network via an operating system interface; and
a service database for storing an initial version of information relating to a customer edge router communicatively coupled to an interface port of a provider edge router for providing the virtual Layer-2 service
wherein the service application comprises instructions recorded on computer readable media to be executed by the service platform for:
monitoring event notifications reported by the network management entity over the operating system interface that relate to an operational status of the interface port;
detecting a change has occurred in said status;
determining information that should relate to the customer edge router has changed; and
interpreting said change to indicate that an intruder system has attempted to participate in the virtual Layer-2 service.

10. The system of claim 9, wherein the service application further comprises instructions for:
recording an identifier of the interface port thereby indicating that the interface port has been selected for security monitoring; and
storing an initial version of the information when security monitoring of the interface port is enabled and the interface port is in an operational state.

11. The system of claim 10, wherein the service application further comprises instructions for:
retrieving a current version of the information; and
comparing the current version to the initial version.

12. The system of claim 11, wherein the information includes one or more Media Access Control or Internet protocol addresses stored in a forwarding information base of the provider edge router.

13. The system of claim 12, wherein the information additionally or alternatively includes other information relating to the customer edge router which is obtainable from the customer edge router via a management entity.

14. The system of claim 13, wherein the virtual Layer-2 service is a virtual private local area network service or a virtual leased line service.

15. The system of claim 9, wherein the operating system interface is a Java messaging system interface.
